(19) United States
(12) Patent Application Publication
(10) Pub. No.: US 2009/0012845 A1
(43) Pub. Date: Jan. 8, 2009

(54) COMMISSION SYSTEM AND METHOD

(76) Inventors: Jessica M. Finley, San Diego, CA (US); Christopher D. Tharp, La Jolla, CA (US); John Harold Finley, Tucson, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 12/163,839

(22) Filed: Jun. 27, 2008

Related U.S. Application Data
(60) Provisional application No. 60/948,266, filed on Jul. 6, 2007.

(51) Int. Cl. G06Q 30/00; G06Q 10/00; G06Q 20/00

(52) U.S. Cl. 705/10; 705/14

(57) ABSTRACT

A system for providing a reward to a consumer based on a travel counselor commission for a selected travel reservation booked for the consumer is disclosed. The method comprises offering a plurality of tours to a consumer; receiving a selection of one of the plurality of tours from a consumer; retrieving commission amount data related to the selected tour; and, providing the reward, to the consumer, based upon a portion of the commission amount. The system may also include purchasing carbon credits and providing a donation to a third party organization related to the selected tour, without charging the consumer for the donation.

### CROSS-REFERENCE TO RELATED APPLICATIONS

This application claims priority to, and the benefit of, U.S. Provisional Application No. 60/948,266, filed on Jul. 6, 2007, which is hereby incorporated by reference in its entirety.

### FIELD OF INVENTION

The present invention generally relates to commissions, and more particularly, to systems and methods for encouraging consumers to use travel consultants by offering to share a portion of the commission with the consumers, and/or by offering carbon credits and donations.

### BACKGROUND OF THE INVENTION

With the increased use of the internet for booking travel, travelers are reducing their use of travel consultants (e.g., agents) and booking with the travel providers directly. Within the travel market, some estimates are that at least half of the travel market takes tours for some or all of their vacations, and many of these potential consumers use the same tour operators each time. Travel consultants are typically limited in their ability to entice such consumers to use travel consultant services because the consumer calls their representative at the tour operation directly. If the consumer is not seeking advice regarding tour selection, the consumer often believes that consultant involvement is an unnecessary and inefficient step in the scheduling process. Such bypassing of travel consultants poses certain problems for consultants, such as, for example, the consultant loses out on nearly 50% (or more) of the market and the consultant losing out on the money-making portion of the business.

In particular, this portion of the business is very profitable because choosing and booking a consumer on a tour is a rather quick transaction compared to a custom-designed trip. For example, for consumer A requesting a custom planned itinerary with a travel consultant, travel consultants may charge a consulting fee of $50-$250 (Average: $100). In addition to this, travel consultants often receive additional commission back from hotels, train tickets or car rentals. If travel consultants use an average 8-10 day vacation to Europe, for two people, staying in hotels, this could total anywhere from $50-$300 in commission. If travel consultants use $150 as an average in this model, travel consultants arrive at a total sale of $250 ($100 fee+$150 in additional commission). These trips take a considerable amount of time to research, plan, produce (present), and finally, book.

In contrast, with consumer B who wants to simply schedule a pre-established tour, the travel consultants simply book the tour, and the travel consultants do not charge a consulting fee. Travel consultants research which tour travel consultants think best fits the consumer, and then book them with that tour operator. This takes very little time. In addition, the tour operator pays the consultants anywhere from 8-15% of the trip cost. If travel consultants use 10% as an average, and make an assumption on the trip (2 person, Europe, 8-10 days) that it costs roughly $2,500-$4,000 (Average $3,250) for a relatively “high-end” tour, the math becomes as follows: $3,250×2=$6500×10% (avg. commission)=$650. In this scenario, travel consultants earn almost three times as much money for the same trip, with only a tenth of the work.

Accordingly, a long-felt need exists for a system and method to encourage consumers to book pre-planned tours, and/or other products and services, through travel consultants.

### SUMMARY OF THE INVENTION

The invention includes a system and method for providing a reward. In one embodiment, the method comprises: offering a plurality of tours to a consumer; receiving a selection of one of the plurality of tours from a consumer; retrieving commission amount data related to the selected tour; and, providing the reward, to the consumer, based upon a portion of the commission amount. The commission amount data comprises a commission amount owed to a travel consultant. The reward may comprise a cash, a check, reduced price of the selected tour, reward points, third party reward points, a coupon, pre-paid transaction card, internet bar coded coupon, discount card, gift card, additional tour, free item, and/or discounted item. The system may also include purchasing carbon credits and providing a donation to a third party organization related to the selected tour, without charging the consumer for the donation.

### BRIEF DESCRIPTION OF THE DRAWINGS

A more complete understanding of the invention may be derived by referring to the detailed description and claims when considered in connection with the FIGURE, wherein like reference numbers refer to similar elements throughout the FIGURE, and:

FIG. 1 is an exemplary flowchart of the commission process.

### DETAILED DESCRIPTION

The detailed description of exemplary embodiments show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

For the sake of brevity, conventional data networking, application development and other functional aspects of the systems (and components of the individual operating components of the systems) may not be described in detail herein.

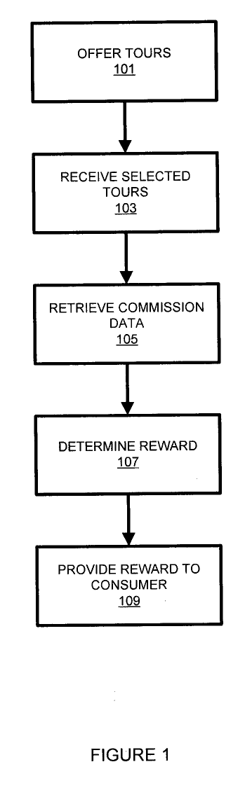

The invention includes a system and method for providing a reward to a consumer based on a travel counselor commission for a selected travel reservation booked for the consumer. With reference to FIG. 1, the method comprises, in one embodiment, offering a plurality of tours to a consumer (step 101); receiving a selection of one of the plurality of tours from a consumer (step 103); retrieving commission amount data including a commission amount related to the selected tour (step 105); determining the reward based upon a portion of the commission amount (step 107); and, providing the reward to the consumer (step 109).

The invention includes a system and method which provides, in one embodiment, a web site which includes a search engine for tours across the globe, a ranking system for tours, and/or a “gift back” incentive. The incentive may be based upon a very large scale for every tour booked. In an exemplary embodiment, the system provides an incentive to the consumer by awarding a portion (e.g., 10%, 25%, 50%, etc) of the host's commission to the consumer. In an embodiment, the consumer is awarded the commission in the form of a “gift”, wherein the gift is a coupon, pre-paid transaction card, internet bar coded coupon, discount card, gift card, additional tours, free or discounted items, and/or any other benefit. The host may be able to obtain the gifts at lower than market value by purchasing the gifts in bulk, or based on certain relationships. The system helps to drive new business to the host, as well as bring increased business to the tour operators listed on the Web site.

A “tour” as used herein, may include a single tour, a group of tours, a tour package (e.g., packaged with other travel related items such as air travel, etc), a tour comprised of a certain group of individuals, multiple tours for one individual or group, a business tour (e.g, a tour of factories or sales offices), an adventure tour (e.g., climb Mt. Everest), a theme tour (e.g., tour certain holy sites related to a particular religion), a tour using one or more modes of transportation (e.g., cruise line, train, bicycle, etc), tours of certain cultures, countries, locations or geographic regions, interest tours (e.g., museums, sports stadiums), tours based on abilities (e.g., hiking long distances), tours based on ethnic, gender, status, disabilities (e.g., singles tours, tours which provide handicapped access sites, etc.) and/or the like.

The target market is comprised of consumers who currently take tours, but book directly with the suppliers (tour operators). In addition, the system targets those not currently taking tours that may be motivated to participate in anticipation of receiving the reward (e.g., incentive). The invention will be attractive to consumers because, for example, it will not be biased in its ranking criteria, it will be providing the exact same tour (price and trip) that the consumer would normally buy directly, and the consumer will be offered substantial gifts in return for participating.

The invention satisfies a long-felt need in the market which has not been satisfied over the years. Such companies as Orbitz and Expedia have created a model in which consolidated airfare and hotels are offered at discounted prices, with a very user-friendly way to search what is available. Another site, Trip Advisor, has a different approach of warehousing hotels. They have their consumers rank their stays based on their experiences. Both methods have proved enormously successful and have revolutionized the way consumers search for hotels and airline travel.

The invention focuses on the tour market. Travelers desire the ability to sufficiently search for multiple tour companies with the criteria they chose coupled with a gift back policy. Exemplary benefits of the present invention are that it will give consumers a central location in which to search and find tours matching their desired vacation. In addition to being able to search and choose tour operators based on various sets of criteria, in an exemplary embodiment, hosts will be offering the tours at discounted rates, or with substantial gifts in return, when compared to the same tours offered by the tour operators themselves.

More particularly, the invention, including its web site(s), includes a large scale search engine and booking terminal. In one embodiment, the robust Web site serves two exemplary functions: First, a large-scale search engine for those wanting to find a reputable tour operator anywhere in the world. The entry screen contains a comprehensive search engine where consumers may input certain parameters returning a top ten list of tour operators that hosts have pre-selected, matching whichever criteria was entered. This list would be based on very strict criteria which, in one embodiment, are followed in all instances, to minimize anyone questioning the standards of the company. Second, at whichever point the consumer views the top ten list (with links, pictures, ratings etc.), hosts will offer very attractive/high-end gifts or cash back incentives.

If a consumer buys a Backroads trip for two to France, the cost of the trip will be exactly the same as the consumer would buy it on the Tour Operator site directly (e.g., $8,000 total). However, the present invention takes half of the commission (e.g., $500 from the $1000 commission ($8,000×12.5%)) and offers it back to the consumer in the form of a reward.

An exemplary end result of this model for hosts include the hosts potentially capturing a large portion of the market of those booking with Tour Operators instantaneously (using a marketing campaign that is effective in education the public about the service). The company accomplishes this by marketing the exact trip, with the exact company, at the exact price, with huge savings/cash back for free. There is little reason for a consumer not to visit the site. What hosts give up in commission back to the consumer(s), hosts gain in overall sales. Additionally, hosts will now have both tour operators and travel product/service companies clamoring to be on the top ten lists of tour offerings, further up the rankings, or one of the companies the host uses for gifting. The site may also offer a Google type Adwords feature, wherein tour operators may purchase certain terms, such that when the consumer searches for those terms, a link to the tour operator site is posted higher in the rankings or in a certain section. Other methods related to pay-for-ranking, pay-for-performance, or other search enhancement features may be incorporated into this invention.

The consumers who may use this product are travelers who take tours or cruises and currently book with the tour operator directly, or consumers who have contemplated taking a tour but are overwhelmed with making the decision. With the added free gift, the consumer has an additional incentive to book tours with the website associated with this invention. This site will be widely utilized because it offers a combination of advice and discounted tours for the exact trips that the consumer books with tour operators or tour agents directly.

As an example, consider the following scenario: iExplore offers a trip to Kenya for 10 nights for $5000. Private guides, transfers, meals etc. are all included. Consumers in the target market would typically call iExplore and book the trip with their representative that they have used in the past. Alternatively, consumers would call for the first time and do the same. In contrast, using the present invention, a consumer logs onto the web site and searches for tours in Kenya given a certain date parameter. The search engine finds all of the applicable tours that hosts have ranked in that area. As an example, hosts have rated iExplore's package as #1. The trip cost on the website is $5000. It is the exact same price, the exact same trip, through the same tour operator. The consumer now wants to book two of these trips. The cost is $10,000. As iExplore would pay the host/travel consultant 10% to bring them a consumer, the host receives $1,000 for this transaction. The competitive advantage of the invention is that hosts are going to give half of this $1000 back to the consumer in the form of a gift. The consumer is now getting the exact trip for less.

This product can be used in different capacities. For example, when the consumer is interested in researching the best tours or cruises as ranked by the site of the invention, this invention will draw those consumers to book a trip with the host site, and it will increase the website hits which are important to advertisers. Moreover, consumers will use the website of the invention to book their tours which will generate the most amount of revenue.

The product positioning is important for the website because it will define both how consumers will use the website (instead of going straight to tour companies to book their trips), and the value they see in the service for doing so. This product is a solution to the problem of trying to find the best tour, without taking the time to do all the research yourself. It also alleviates the problem of going to a host for advice, this way all steps can be accomplished from the home computer. The consumer is getting the same trips that they can book through the tour operator, with a very sizable (cash equivalent) reward in return.

Exemplary components of the site comprise a search engine which receives input such as Destination, Date, Length of Time, Activity (optional)). This would search the pre-populated archives and return a list of the top 10 tours that go to that area specified. The tours are ranked #1-#10 with descriptions/pictures, rationale for the ranking, etc. Another component is the online booking/payment (with the appropriate security). Each trip would have the price listed alongside it. The price would match exactly to the Tour Operator's site. If the consumer wants to book, they would click on the price where it would output them to a payment confirmation with the appropriate detail that the tour requests. If the consumer calls the Tour Operator, and books through their site, they may not be eligible to receive the gift. This may encourage payment through the website, and not obtained directly by the Tour once they are looped in. The system includes online security built into the website as people will be inputting their personal banking information. In addition, tour prices and descriptions may be linked to the Tour Operator's site. This way, if trips or prices change, they will be reflected accordingly on the website. If hosts are not able to build their own payment screen for the Tour, the consumer may need to call or contact the host to inform the host of their chosen trip. Hosts would then contact the Tour Operators to provide the relevant detail. This ensures their booking comes through the host company, and there can be no question in the payment of the commission.

The system may also include links to tour/product sites. The site may link to the specific tours so the consumer can read about the tour/see pictures etc. Again, these may link to ensure they always reflect the detail on the websites. The system may also provide for web synching to other sites. If a consumer books a trip that offers $500 in online gift certificates to Patagonia etc., at the time of booking on the website the Patagonia account should fund. This makes it more seamless and removes the host from the supply chain. Such features may include pre-positioned partnerships (contracts) with partner sites.

The system may also include assigned gifts to each tour, or a catalog of gifts to choose from based on price of tour. The rewards may be pre-determined, random, change periodically, and/or other method of allocation. In addition, the system may determine when the consumer receives the gift incentive (e.g., once they have purchased a trip). Hosts may adopt the Tour Operators cancellation policy on the trip. Hosts may have the same policy for the gift portion of the transaction as hosts would not want a consumer to receive a gift, then cancel a trip. One option here is to only allow the gift transaction to occur, after a pre-determined amount of time.

The system may also include tour descriptions. Once a consumer has searched their parameters, a top ten list may be returned that lists the tours that match their search as well as a ranking of those tours. The tours listed may include all relevant detail (and pictures) that the consumer would see if they were on that particular Tour Operator's home Web site. They may be as attractive and enticing (visually) as they would be elsewhere. In one embodiment, all links and sub-links listed on the Tour Operator's Web site may be included.

An exemplary Web site Layout may include description of what the site and company does, entry page with Search Engine to allow the consumer to choose Country, date and activity type, etc. The criteria selected then brings the consumer to another page which may include the Top 10 list of Tour Operators matching the criteria. Each operator may be listed with a link to the specifics of the trip, the price of the trip and the applicable reward.

Once a trip is selected, a new web page appears showing terms and conditions (of both the website and the respective Tour Operator). A phone number may be listed here to call with questions. The host then books the tour and instructions are provided on how to claim or use the reward, for example, via another link.

Other exemplary features of the invention include the invention accurately portrays what hosts offer, how hosts do it, and shows consumers that they can buy the same tours through the website, but receive much more (at discounted rates and with large-scale gifts). The website is comparable or better than a tour providers' website, so that consumers are less likely to abandon using the site because of frustration. The ‘ranking’ system is viewed as both legitimate and straightforward. Hosts state on the site that hosts are not paid by the tour operator to have their trip listed on the website.

The invention includes the following exemplary competitive advantages: A search engine for tour companies worldwide, an unbiased rating or listing system of those tours (what hosts choose to list as our top tours etc), and substantial gifts in return for booking them through our Web site. These tours are the exact same tours that exist currently on all major tour operator Web sites.

In an exemplary embodiment, the invention includes a listing system for these tour operators (in a manner that the general public can trust). In other words, if hosts are to believe that a consumer is going to trust who is listed in our “top ten” lists, hosts need to identify a way to rank people so hosts are consistent and consumers trust it.

In an exemplary embodiment, the gift incentive takes the form of either applicable gifts to the trip (binoculars with a safari etc) or gift certificates to travel-related suppliers (Buy Trip A and receive $600 to Patagonia (online)). Either way, hosts establish relationships with these companies to either send their products when the trip is purchased or fund on online account in the same manner. The host may buy these products with proceeds from the tours. These partnerships with prestigious members of the travel community may also influence which other suppliers/vendors participate. In addition, as added revenue, hosts may offer retail dollars to the consumers, while hosts are paying wholesale. This will allow the host to earn a bit more money on each of the gift offerings. The listed trips may also be synched with appropriate gifts/cash-back incentives.

In another embodiment, the invention includes the incorporation of “green” (e.g., environmentally friendly) related features. The system includes CarbonFund related functions to offset the damage done to the environment by travel, such as offsetting all (or any portion of) manner of travel from consumers' vacation—airfare, rental cars, hotels, trains etc for minimal or no charge by the host. In one embodiment, the system buys carbon credits for consumers, and donates money from trips towards local conservation and sustainability efforts. The system includes functions and features in order to give back to local groups/projects who are active in the areas in which consumers are traveling, along with sustainability and minimizing the environmental impact travel causes our world. As an example, for consumers traveling on a vacation to the rain forest in South America, as part of the reward to the consumer, the system donates money to the Rainforest Alliance. The carbon credits and donations may relate to tours, but also to simple functions such as booking a hotel in New York City.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: consumer data; merchant data; financial institution data; and/or like data useful in the operation of the system. As those skilled in the art will appreciate, user computer may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe or the like. User computer can be in a home or business environment with access to a network. In an exemplary embodiment, access is through a network or the Internet through a commercially-available web-browser software package.

As used herein, the term “network” shall include any electronic communications means which incorporates both hardware and software components of such. Communication among the parties may be accomplished through any suitable communication channels, such as, for example, a telephone network, an extranet, an intranet, Internet, point of interaction device (point of sale device, personal digital assistant (e.g., Palm Pilot®, Blackberry®), cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The computing unit of the web consumer may be further equipped with an Internet browser connected to the Internet or an intranet using standard dial-up, cable, DSL or any other Internet protocol known in the art. Transactions originating at a web consumer may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web consumers connecting through a web server. Firewall may reside in varying configurations including Stateful Inspection, Proxy based and Packet Filtering among others. Firewall may be integrated within a web server or any other CMS components or may further reside as a separate entity.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, Macromedia Cold Fusion, Microsoft Active Server Pages, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a consumer-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the terms “host”, “travel consultant”, tour operator”, “end user”, “consumer”, “consumer”, “cardmember”, “business,” and/or “merchant” may be used interchangeably with each other, and each shall mean any person, entity, machine, hardware, software or business. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The consumer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the consumer and issuing bank. In an exemplary implementation, the electronic commerce system is implemented as computer software modules loaded onto the consumer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The invention can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

The invention can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

While the steps outlined above represent a specific embodiment of the invention, practitioners will appreciate that there are any number of computing algorithms and user interfaces that may be applied to create similar results. The steps are presented for the sake of explanation only and are not intended to limit the scope of the invention in any way.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims of the invention. It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above. Reference to an element in the singular is not intended to mean “one and only one” unless explicitly so stated, but rather “one or more.” Moreover, where a phrase similar to at least one of A, B, and C′ is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, Band C, or A and B and C.

We claim:

1. A method for providing a reward, said method comprising:
offering a plurality of tours to a consumer;
receiving a selection of one of said plurality of tours from a consumer;
retrieving commission amount data including a commission amount related to said selected tour;
determining said reward based upon a portion of said commission amount; and,
providing said reward to said consumer.

2. The method of claim 1, wherein said commission amount data comprises a commission amount owed to a travel consultant.

3. The method of claim 1, wherein said reward comprises at least one of: cash, a check, reduced price of said selected tour, reward points, third party reward points, a coupon, pre-paid transaction card, internet bar coded coupon, discount card, gift card, additional tour, free item, and discounted item.

4. The method of claim 1, wherein said reward is at least one of: pre-determined, selected from a catalog, random, and changes periodically.

5. The method of claim 1, further comprising offering said selected tour at a discounted price.

6. The method of claim 1, further comprising receiving, from said consumer, payment related to a price associated with said selected tour, wherein said payment is reduced by said reward to an amount less than said price.

7. The method of claim 1, further comprising purchasing said rewards in large quantities to reduce a unit price of each of said reward.

8. The method of claim 1, wherein said selected tour comprises at least one of: a single tour, a group of tours, a tour packaged with other travel related items, a tour comprised of a certain group of individuals, multiple tours for one individual or group, a business tour, an adventure tour, a theme tour, a tour using different modes of transportation, a tour of certain cultures, countries, locations or geographic regions, an interest tour, and a tour based on ethnic, gender, status, abilities or disabilities.

9. The method of claim 1, further comprising enabling a consumer to search among said plurality of tours based upon entered search criteria.

10. The method of claim 1, further comprising pre-selecting said plurality of tours based upon at least one of: certain travel consultant criteria and certain consumer criteria.

11. The method of claim 1, wherein said offering said plurality of tours is based upon at least one of: certain travel consultant criteria and certain consumer criteria.

12. The method of claim 1, further comprising eliminating tours from said plurality of tours based upon consumer feedback.

13. The method of claim 1, wherein said offering said plurality of tours lists tours based upon at least one of: pay-for-ranking and pay-for-performance.

14. The method of claim 1, wherein providing said reward occurs after a pre-determined amount of time based upon a cancellation policy related to said selected tour.

15. The method of claim 1, wherein said reward is a donation to a third party organization, wherein said donation is related to said selected tour.

16. The method of claim 1, further comprising purchasing carbon credits and providing a donation to a third party organization related to said selected tour.

17. The method of claim 1, further comprising purchasing carbon credits and providing a donation to a third party organization related to said selected tour, without charging said consumer for said donation.

18. A method for receiving a reward, said method comprising:
selecting one of a plurality of tours; and,
receiving a reward based upon a portion of a commission amount received by a travel consultant related to said selected tour.

19. A computer-readable medium having stored thereon a plurality of instructions, said plurality of instructions comprising:
instructions to offer a plurality of tours to a consumer;
instructions to receive a selection of one of said plurality of tours from a consumer;
instructions to retrieve commission amount data including a commission amount related to said selected tour;
instructions to determine said reward based upon a portion of said commission amount; and,
instructions to provide said reward to said consumer.
